(19) United States
(12) Patent Application Publication
(10) Pub. No.: US 2002/0103678 A1
(43) Pub. Date: Aug. 1, 2002

(54) Multi-risk insurance system and method

(76) Inventors: Swinton B. Burkhalter, Atlanta, GA (US); Frank M. Sexton, Atlanta, GA (US)

Correspondence Address: Joseph H. Golant, Suite 3500, 77 West Wacker Drive, Chicago, IL, 60601-1692, US

(21) Appl. No.: 09/775,335

(22) Filed: Feb. 1, 2001

(51) Int. Cl. G06F 17/60

(52) U.S. Cl. 705/4

(57) ABSTRACT

A multi-risk insurance system and method are disclosed resulting in a single insurance policy with many coverages being included. These coverages include life, health, disability, major medical, critical illness, long-term care, automobile, homeowners, fire, theft, renters, personal liability, general liability and the like. The result for the insured is a savings in time and expense. The insurer lowers administrative costs, sales expenses and inefficiencies.

### BACKGROUND OF THE INVENTION

1. Field of the Invention

The present invention relates to a multi-risk insurance method and system and more particularly to a multi-risk insurance method and system for achieving substantial efficiencies.

2. Description of the Related Art

There are many types of insurance available in the marketplace including health, life, disability, major medical, critical illness, long term care, automobile, homeowners, fire, theft, renters, personal liability and general liability, for example. Usually these different types of insurance are sold either alone or in small groups by different companies. Each of these companies has its own overhead expenses, selling expenses and underwriting costs. This practice is inefficient for insurance companies and costly for consumers.

### BRIEF SUMMARY OF THE INVENTION

The inefficiencies which have developed in the insurance industry due to over specialization of various companies relating to the type of insurance they sell is extremely burdensome. The present invention overcomes these problems by providing a method for forming an insurance plan comprising the steps of collecting data concerning multiple insurance coverages including life, health, disability, major medical, critical illness, long term care and property and casualty, collecting data about an individual or other risk to be insured, inputting the data about the individual or other risk to be insured and the coverages into a data processing apparatus, collecting regulatory requirements, inputting the regulatory requirements into the data processing apparatus, selecting three or more coverages to form a policy or contract, comparing the policy with the regulatory requirements and displaying the resultant policy. The invention also includes an insurance system comprising a data processing apparatus having input means for receiving information and instructions, the data processing apparatus having base product data and information concerning a prospective insured, the data processing apparatus also having information concerning multiple insurance coverages including life, health, disability, major medical, critical illness, long term care and property and casualty, a policy generated by said data processing apparatus based upon a selection of three or more of the insurance coverages and a display of the resulting policy by said data processing apparatus.

An object of the present invention is to provide an insurance method and system which provides total insurance protection in a very efficient manner. Another aim of the present invention is to provide an insurance method and system which saves time for potential insureds or policy owners. Yet another aspect of the present invention is to provide an insurance method and system which substantially reduces underwriting costs, sales charges and administrative expenses for an insurance company. Still another advantage of the present invention is to provide an insurance method and system which results in higher premiums per policy for insurance companies and a better retention record by insureds or policy owners. A further objective of the present invention is to provide an insurance method and system that reduces total premium charges or increases benefits to policy owners.

A more complete understanding of the present invention and other aspects, objects, aims and advantages thereof will be gained from a consideration of the following description of the preferred embodiments read in conjunction with the accompanying drawing provided herein.

### BRIEF DESCRIPTION OF THE SEVERAL VIEWS OF THE DRAWING

FIG. 1 is a flow diagram of the present invention.

FIG. 2 is another flow diagram of the present invention.

### DETAILED DESCRIPTION OF THE INVENTION

While the present invention is open to various modifications and alternative constructions, the preferred embodiments shown in the drawing will be described herein in detail. It is understood, however, that there is no intention to limit the invention to the particular forms disclosed. On the contrary, the intention is to cover all modifications, equivalent structures and methods, and alternative constructions falling within the spirit and scope of the invention as expressed in the appended claims.

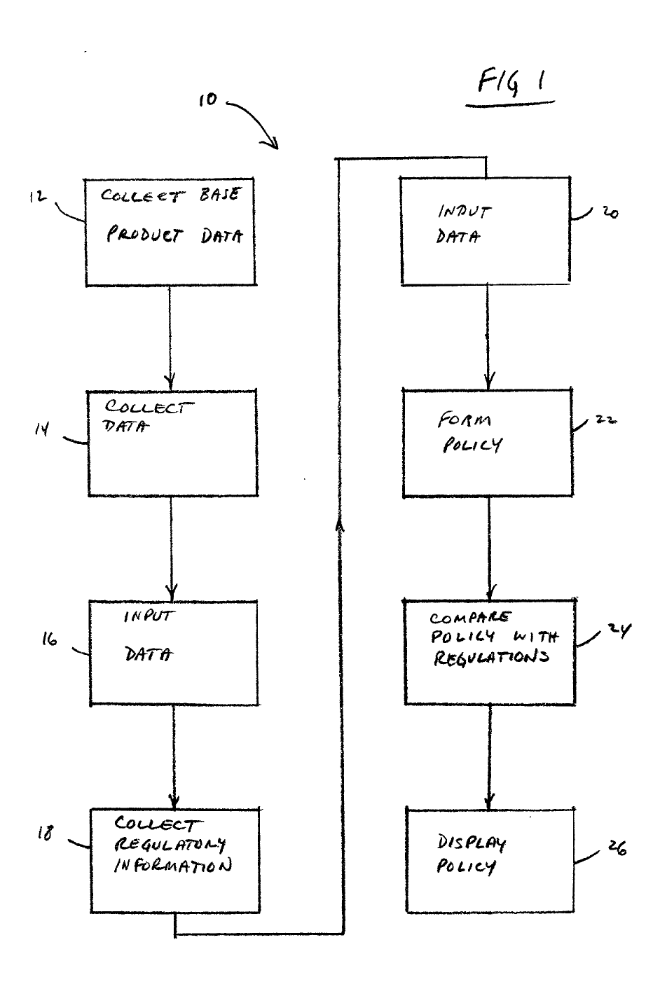

Referring now to FIG. 1, a method 10 for forming an insurance plan is illustrated and comprises the steps of collecting Base Product Data 12 concerning multiple insurance coverages including life insurance, health insurance, disability insurance, major medical insurance, critical illness insurance, long term care insurance and various property and casualty insurance, such as automobile insurance, homeowners insurance, fire insurance, theft insurance, renters insurance, personal liability insurance, general liability insurance and the like.

Base Product Data is defined here as tables produced by insurance companies for each type of life policy contract offered by that company. The Data is usually derived from the pricing by these companies of their insurance products. In turn the calculation of insurance rates and values requires information and assumptions regarding five elements: 1) the probability of the event insured against occurring; 2) the time value of money; 3) the benefits promised; 4) expenses; and 5) profits and contingencies.

The probability of the event, death for instance, in the case of life insurance, is usually determined from mortality tables which show yearly probabilities of death. These tables show incidences of death for a given group of insurers over time—often from birth to the death of the final person in the group. These tables also constitute the foundation upon which the expected cost of life insurance is based. The time value of money relates to the fact that life insurance companies, for example, collect premiums in advance of providing insurance coverage. In longer term coverage, that portion collected but not needed immediately to cover losses and expenses is invested and produces earnings that are used to supplement premium income to fund future expected benefits and outgoing expenses. In such cases, insurers discount premiums in advance, and there is a recognition of the fact that they will earn interest on the accumulated funds. The benefits promised may vary from policy to policy. The premium computation must take into account the period of coverage, the level of coverage, as well as all other factors related to the benefits promised the insured under the contract. Included here is a likelihood of policy owners voluntarily terminating their policies.

Life insurance rates that are calculated to recognize the probability of death occurring, the time value of money and the benefits promised are referred to as “net rates”. They do not make allowances for the expenses the insurer incurs in selling, issuing and maintaining the policy, nor do they make provisions for profits or unforeseen contingencies. When “loading” for expenses, contingencies and profits are added to the “net rate”, the “gross rate” is obtained. The gross rate is the amount actually charged to policy holders.

In computing net and gross rates, each insurance company considers its objectives and its past experience for each factor involved. Even though the above data is followed in principal by many life insurers, a more common method of deriving a company's gross premium rates structure is for the insurer to select gross rates for pivotal ages (usually based on market and competitive considerations) and then the test of these selected rates against its objectives and expectations as to realistic future experience. If the test rate does not produce the profit and desired results, the rate will be changed and the test repeated. With this procedure, the insurer does not calculate a net rate and add amounts to cover expenses, profits and contingencies; instead, the insurer simply tests a target gross rate against the company's anticipated future operating experience.

Still another approach to establish a gross premium rate structure is to calculate gross premium rates directly through the use of realistic assumptions of: 1) interest; 2) mortality; 3) expenses; 4) number of lapsed policies; and 5) profits and contingencies. With cash values and a dividend scale assumed, the gross premium rate is determined by a mathematical equation. Regardless of how the tentative gross rate is derived, it is tested against the company's anticipated future operating experience. The gross premium rate structure of a new policy is tested by the issuing company, not only to determine if the rate structure will develop sufficiently high asset accumulation to provide the surrender values and death and other benefits promised under the contract, but to make sure the rate structure meets regulatory requirements. The gross premium rate calculation produces the tables mentioned above showing values, such as cash values, dividend values and death benefit values for each gender, age and risk classification for each type of insurance contract offered for sale by each life insurance company.

It is to be understood that the data developed is not guaranteed, but is a projection of future values based on certain assumptions concerning the pricing elements. The results actually produced for the policy owner will vary from the projection based upon actual experience. The above list intends to include all possible consumer type insurance coverages available at the present date and any additional coverages which may be developed in the future. Of course, it is also to be understood that specific data processing apparatus may contain data for some of the coverages mentioned but not for all. This does not change the reach of the present invention. Multiple apparatus may be used at the convenience of the insurer. In addition, if more than one computer is used, or if there is some narrowing of the risks or coverages a company is willing to insure, the method still comes within the claims of the invention. Today, most companies severely limit the types of coverages they issue and it is the intent of the present invention to broaden that range of coverages to a considerable degree.

The insurance company also collects data 14 about a prospective insured or on another risk to be insured. Such data when relating to an individual may include his/her sex, age, marital status, individual medical history, family medical history, usage of alcohol, tobacco and drugs, automobile driving record, credit report, financial statement, criminal record, current medical examination report and results, and physical disabilities and impairments. When the insurance is for another risk, the data may include the value of the property, if applicable. This is followed by inputting 16 the data collected about the individual or other risk and the coverages into a data processing apparatus. The method also includes collecting regulatory information 18, such as Section 7702 of the Internal Revenue Code and various state requirements. Regulatory requirements generally mean that life insurance contracts comply or qualify under applicable law such as Section 7702 of the Internal Revenue Code. Section 7702 states a test that has two alternatives and whichever alternative is chosen, that test must be met for the entire life of the contract. The first test applies mainly to traditional cash-value policies. This cash-value accumulation test requires that, by the terms of the contract, the cash surrender value cannot at any time exceed the net single premium required to fund future contract benefits. The net single premium is calculated by assuming an interest rate equal to the greater of 4% or the rate guaranteed in the contract. The mortality charges are based on those specified in the contract, or, if not specified, the mortality charges used in determining statutory reserves for that contract. For contracts issued after October 20, 1988, the mortality charges must be reasonable and cannot exceed those of the prevailing mortality tables required by state insurance regulators.

The second test intended for universal life and related policies requires that both a guideline premium and a death benefit test be met. The guideline premium requirement is met if accumulated premiums paid under the contract do not exceed, at any time, the greater of the “guideline single premium” or the sum of the “guideline level premiums” at the time. The guideline single premium is computed using interest at the greater rate of 6% or the rate guaranteed in the contract. Mortality charges are based on the same standard as applied to the cash-value accumulation test. The guideline level premiums are computed in a manner similar to the computing of the guideline single premium, except that the minimum interest rate is 4% rather than 6%. The death benefit requirement is met if death benefits exceed 250% of the cash value for an insured of attained age up to age 40, grading down to 100% of the cash value at attained age 55. Thus, if a 35 year old owns a cash-value policy whose cash value is $10,000 the policy death benefit must at least be $25,000 for the policy to meet the death benefit requirement. The regulatory information and the Section 7702 and state requirements are also inputted 20 into the data processing apparatus.

A policy for the individual or other risk is formed 22 by selecting three or more coverages listed above. This proposed policy is then compared 24 with the regulatory requirements to ensure compliance. Thereafter, the policy is displayed 26 by the computer, such as on a screen or by a printout or in any other convenient method.

There are numerous advantages achieved by the present method. These include a substantial savings of time for the prospective insured or policy owner because the underwriting requirements of multiple policies, such as medical examinations, credit reports, medical data retrieval, and the like is substantially reduced. Also, the sales process for the prospective insured or policy owner is greatly simplified because he/she deals with but a single company and a single sales representative. The company in turn saves money by reducing total underwriting costs by having reduced sales charges and by lower administrative costs. This savings allows the insurance company to reduce its premiums for such multi-risk policies below the aggregate premiums that would have been charged if the insured was required to obtain the same coverages from numerous different companies.

There are also advantages to the issuing insurance company in that each policy will generate a higher premium than was previously the case while reducing per unit overhead expenses. It is expected that the company will also enjoy a better retention rate once the policy is in force because it is expected that when any one of the coverages is considered to be important to the insured or policy owner, he/she will maintain the entire policy in force. In the past, the insured or policy owner would generally pick and choose which policies he/she wished to carry forward each time he/she was required to pay a premium. The insured or policy owner is also expected to benefit by having ongoing favorable claim experience that results in reduced premiums or enhanced benefits and by having better customer service available from the insurance company because each multi-risk policy is more valuable to the company.

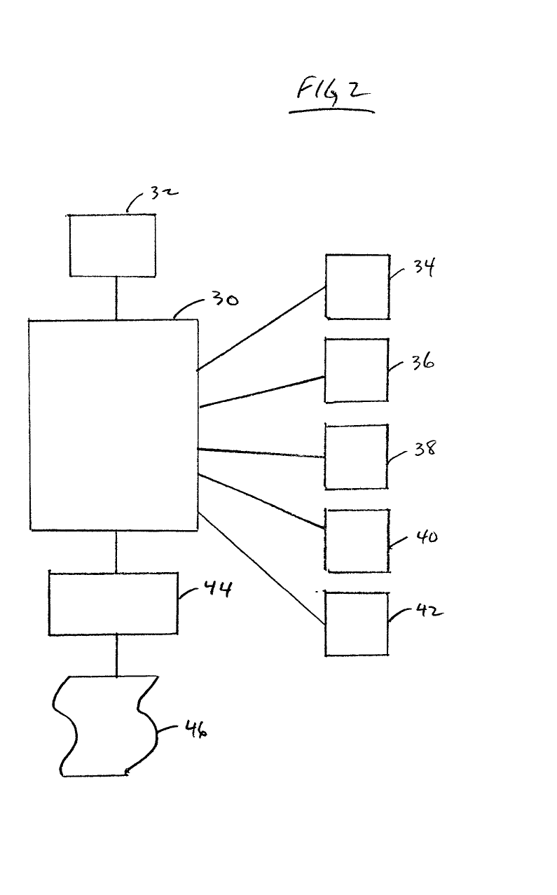

Referring now to FIG. 2, a data processing apparatus 30 is provided having input means 32 such as a keyboard or voice recognition software or any other means that may exist today or which may be developed in the future for receiving information and instructions. The data processing apparatus includes in its memory Base Product Data 34 and information concerning a prospective insured or risk 36. The data processing apparatus also has information concerning multiple insurance coverages 38 such as life insurance, health insurance, disability insurance, major medical insurance, critical illness insurance, long term care insurance and property and casualty insurance. It is to be noted that this list is not exhaustive and new insurance plans will in all likelihood be developed in the future. It is intended that the data processing apparatus includes information and data relating to all of the coverages as well as new ones that may be developed so that the company can offer the broadest possible multi-risk insurance policy. However, it is also contemplated that specific companies may decide to only maintain information concerning coverages which are the most popular, and they may not deal with more exotic programs. This will still be covered by the invention as the intent here is to enable the construction of a multi-risk policy which includes many but not all coverages. Such a policy need not contain every possible type of insurance available in the marketplace.

A policy is generated by the computer 40 based upon a selection by the prospective insured or policy owner of three or more of the multiple coverages available. The resulting policy is compared 42 by the data processing apparatus to regulatory requirements. Finally, the computer transfers appropriate data to a display device 44 which provides the resulting policy 46 to a customer either on a computer screen or on paper through a printer or in any other manner available or which may become available in the future.

As mentioned, there are a number of advantages to a multi-risk policy to both the insured or policy owner and the insurer, insurance company. The insured or policy owner saves time because for a multi-risk policy there is a reduction of the underwriting requirements when compared to multiple policies which would have required multiple medical examinations, multiple application forms, multiple medical records and the like. The insured or policy owner also deals with a single company and perhaps a single sales representative of that company. Further, the insured or policy owner may receive better service from his insurance company. The insurance company saves money by reducing total underwriting costs, sales expenses and administrative costs when the coverages are aggregated into one policy. Also, there will be a higher premium per policy and this lowers unit overhead cost. There is also likely to be a better retention of policy experience once the insurance is in force. Finally, customers are likely to receive lower overall premium charges for the combined coverages because some of the savings enjoyed by insurance companies can be passed on to insureds or policy owners. Favorable claim experience could result in premium reductions or improved benefits for customers.

The specification describes in detail several embodiments of the present invention. Other modifications and variations will under the doctrine of equivalents come within the scope of the appended claims. For example, the number and specific mix of coverages are within the coverage of the attached claims. Also, for example, a married, 40 year old man with a family may desire a multi-risk policy that includes life insurance, health insurance, disability insurance, major medical insurance, automobile insurance, homeowners insurance, fire insurance, theft insurance and personal liability insurance. Even though this mix of coverages is broad, it is noted that not all of the possible coverages mentioned above are included. Still other alternatives will also be equivalent as will many new plans and technologies. There is no desire or intention here to limit in any way the application of the doctrine of equivalents.

1. A method for forming an insurance plan comprising the steps of:
collecting data concerning multiple insurance coverages, including life, health, disability, major medical, critical illness, long term care and property and casualty;
collecting data about an individual or other risk to be insured;
inputting said data about the individual or other risk and the coverages into a data processing apparatus;
collecting regulatory requirements;
inputting said regulatory requirements into said data processing apparatus;
selecting three or more coverages to form a policy;
comparing said policy with said regulatory requirements; and
displaying the resulting policy.

2. A method as claimed in claim 1 wherein:
the data about an individual includes information concerning one or more of the following subjects: sex, age, marital status, individual medical history, family medical history, usage of alcohol, tobacco and drugs, automobile driving record, credit report, financial statement, criminal record, current medical examination report and results, and any physical disabilities and impairment.

3. An insurance system comprising:
a data processing apparatus having input means for receiving information and instructions;
said data processing apparatus having base product data and information concerning a prospective insured;
said data processing apparatus also having information concerning multiple insurance coverages including life, health, disability, major medical, critical illness, long term care and property and casualty;
a policy generated by said data processing apparatus based upon a selection of three or more of said insurance coverages; and
a display operatively connected to said data process apparatus for showing said policy generated by said data processing apparatus.

4. A system as claimed in claim 3 wherein:
the information concerning a prospective insured includes information concerning one or more of the following subjects: sex, age, marital status, individual medical history, family medical history, usage of alcohol, tobacco and drugs, automobile driving record, credit report, financial statement, criminal record, claim experience, current medical examination report and results, and any physical disabilities and impairments.

5. A system as claimed in claim 3 wherein:
base product data includes the probability of the event insured against occurring, the time value of money, the benefits promised, expenses and profits and contingencies.

6. A system as claimed in claim 4 wherein:
base produce data includes the probability of the event insured against occurring, the time value of money, the benefits promised, expenses and profits and contingencies.
